(19) United States
(12) Patent Application Publication
(10) Pub. No.: US 2025/0217915 A1
(43) Pub. Date: Jul. 3, 2025

(54) PROVIDING DIFFERENTIATING INFORMATION INCLUDED IN SIMILAR EVENTS

(71) Applicant: MOTOROLA SOLUTIONS, INC., Chicago, IL (US)

(72) Inventors: Piotr Dziedzic, Krakow (PL); Wojciech Korzybski, Krakow (PL); Oliwia Strzelec, Warszawa (PL); Grzegorz Szurek, Krakow (PL); Jaromir Wegrzyn, Trzebownisko (PL)

(21) Appl. No.: 18/400,328

(22) Filed: Dec. 29, 2023

(51) Int. Cl. G06Q 50/26

(52) U.S. Cl. CPC G06Q 50/265

(57) ABSTRACT

One example electronic computing device includes an electronic processor configured to determine, based on information regarding a first event and information regarding a first user selected to respond to the first event, whether the first event is similar to a plurality of previous events to which the first user has responded. In response to determining that the first event is similar to the plurality of previous events, the electronic processor determines whether there are any significant differences between the first event and the plurality of previous events to which the first user has responded. In response to determining that there is a significant difference between the first event and the plurality of previous events to which the first user has responded, the electronic processor provides, to a communication device associated with the first user, a notification regarding the first event and an indication of the significant difference.

### BACKGROUND OF THE INVENTION

Surveillance systems may be used at many locations for security purposes, recordkeeping purposes, and/or the like. Some surveillance systems include one or more video cameras and/or sensors to monitor various areas for various events (e.g., trespassing, detection of emergencies, etc.). Information regarding these various events may be provided to a security officer and/or another person (e.g., a manager, a foreperson, residential property owner, etc.) for investigation/handling. Similarly, but in a different context, public safety incidents/events such as a wellness check, a reported fire, a reported crime, etc. may be assigned (e.g., by a dispatcher) to a public safety officer for investigation/handling.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a communication system according to one example embodiment.

FIG. 2 is a block diagram of a communication device included in the communication system of FIG. 1 according to one example embodiment.

FIG. 3 is a block diagram of a cloud-based electronic computing device included in the communication system of FIG. 1 according to one example embodiment.

FIG. 4 is a flowchart of a method of providing differentiating information included in similar events according to one example embodiment.

FIG. 5 illustrates an example graphical user interface (GUI) that may be displayed on a display of the communication device of FIG. 2 according to one example embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

As noted, information regarding an ongoing event (such as a possible security or emergency event detected by a surveillance system or a public safety incident/event reported to a public safety agency) may be provided to an officer/user (e.g., a security officer, a public safety officer, etc.) for investigation/handling. Over extended periods of time (e.g., the officer's work shift, work week, work month, work year, and/or work career), the officer may receive requests to handle similar events with similar information. For example, a security officer may receive information about the same alarm in a museum multiple times throughout their work shift if a sensor associated with the alarm often triggers false alarms or alarms with that are triggered accidentally. As another example, a public safety officer may often be dispatched to the same residence for a wellness check on the same person throughout a work year.

Each event that is requested to be handled by an officer may be handled in a number of different ways and often depends upon the judgment of the officer who is assigned to investigate/handle the event. When deciding how to handle a received assignment involving an event, the officer makes decisions based on the information that they have been provided regarding the event. However, making proper decisions is a complex task, and the officer's decision-making may be influenced by biases such as cognitive bias or unconscious bias that may cause the officer's decision regarding how to handle a given event to deviate from the manner in which they were trained to handle the event.

Cognitive bias is a systematic error in thinking that occurs when people are processing and interpreting information in the world around them. Cognitive bias may affect the decisions and judgments that are made by a person. Unconscious bias describes a subconscious attitude that affects the way individuals feel and think about others around them. Biases may affect decision-making and may trigger jumping to conclusions that may not be correct.

As an example of how biases may affect an officer who has been assigned to handle an event, a security officer may receive an alarm notification from the same sensor ten times during a work shift. Upon investigating this alarm notification the first nine times, the security officer determines that the alarm notification is a false alarm. Accordingly, when the officer receives the alarm notification for the tenth time, the security officer may evaluate the alarm notification in a biased manner and may assume that the alarm notification is another false alarm without adequately investigating or without investigating at all. Accordingly, if the tenth alarm notification is not a false alarm, the alarm notification will be improperly ignored by the security officer due to their bias caused by the first nine alarm notifications that were false alarms.

Existing surveillance systems and dispatch systems merely provide information about a current event to an officer assigned to handle the event. Existing surveillance systems and dispatch systems do not differentiate a current event (e.g., alarm notification, incident assignment, etc.) from past similar events. Accordingly, the handling of events by providing information to officers using such existing surveillance systems and dispatch systems makes the officers more susceptible to cognitive and unconscious bias, which increases the likelihood that an event is handled improperly. Accordingly, there is a technological problem with surveillance systems and dispatch systems causing increased user error.

To address this technological problem, disclosed are, among other things, methods, devices, and systems to provide differentiating information between a current event to which a user is assigned and previous similar events to which the user was assigned. In some instances, the disclosed methods, devices, and systems address the technological problem by determining whether a current event is similar to a plurality of previous events to which a first officer/user assigned to the current event has responded. In response to determining that the current event is similar to a plurality of previous events to which the first user has responded, the disclosed methods, devices, and systems determine one or more significant differences between the first event and the plurality of previous events to which the first user has responded. An indication of the one or more significant differences is then provided to a communication device of the first user to emphasize the one or more significant differences.

The disclosed methods, devices, and systems provide, among other things, mechanisms and techniques for reducing or eliminating bias in the decision-making of the user handling the current event by specifically highlighting differences (or a single difference) in seemingly identical or similar previous events that the user handled. The goal of such highlighting is to call the user's attention to these differences to encourage the user to take these differences into account when determining how to handle the current event. Such highlighting addresses the above-noted technological problem by providing an improved user interface/user experience that results in better decision-making regarding the handling of current events by officers. For example, the disclosed methods, devices, and systems aim to prevent the tenth alarm notification from being ignored in the above-noted example by highlighting a difference in the tenth alarm notification from the previous nine alarm notifications that the officer experienced (e.g., when the alarm notification is for an emergency door being opened, and the first nine alarm notifications indicated the door was opened for one second while the tenth alarm notification indicated that the door was opened for ten seconds). Additional detailed examples are provided herein.

One embodiment provides an electronic computing device that may include a network interface, and an electronic processor coupled to the network interface. The electronic processor may be configured to receive information regarding a first event. The information regarding the first event may include a plurality of event parameters of the first event. The electronic processor may also be configured to receive information regarding a first user selected to respond to the first event. The electronic processor may also be configured to determine, based on the information regarding the first event and the information regarding the first user, whether the first event is similar to a plurality of previous events to which the first user has responded by comparing each of the plurality of event parameters of the first event to a plurality of event parameters of the plurality of previous events to which the first user has responded. In response to determining that the first event is similar to the plurality of previous events to which the first user has responded, the electronic processor may also be configured to determine whether there are any significant differences between the first event and the plurality of previous events to which the first user has responded by comparing each of the plurality of event parameters of the first event to corresponding event parameters of the plurality of event parameters of the plurality of previous events to which the first user has responded. In response to determining that there is a significant difference between the first event and the plurality of previous events to which the first user has responded, the electronic processor may also be configured to provide, to a communication device associated with the first user, a notification regarding the first event and an indication of the significant difference.

Another embodiment provides a method of providing differentiating information included in similar events. The method may include receiving, with an electronic processor of an electronic computing device, information regarding a first event. The information regarding the first event may include a plurality of event parameters of the first event. The method may also include receiving, with the electronic processor, information regarding a first user selected to respond to the first event. The method may also include determining, with the electronic processor and based on the information regarding the first event and the information regarding the first user, whether the first event is similar to a plurality of previous events to which the first user has responded by comparing each of the plurality of event parameters of the first event to a plurality of event parameters of the plurality of previous events to which the first user has responded. The method may also include in response to determining that the first event is similar to the plurality of previous events to which the first user has responded, determining, with the electronic processor, whether there are any significant differences between the first event and the plurality of previous events to which the first user has responded by comparing each of the plurality of event parameters of the first event to corresponding event parameters of the plurality of event parameters of the plurality of previous events to which the first user has responded. The method may also include in response to determining that there is a significant difference between the first event and the plurality of previous events to which the first user has responded, providing, with the electronic processor and to a communication device associated with the first user, a notification regarding the first event and an indication of the significant difference.

For ease of description, some or all of the example systems and devices presented herein are illustrated with a single example of each of its component parts. Some examples may not describe or illustrate all components of the systems or devices. Other example embodiments may include more or fewer of each of the illustrated components, may combine some components, or may include additional or alternative components.

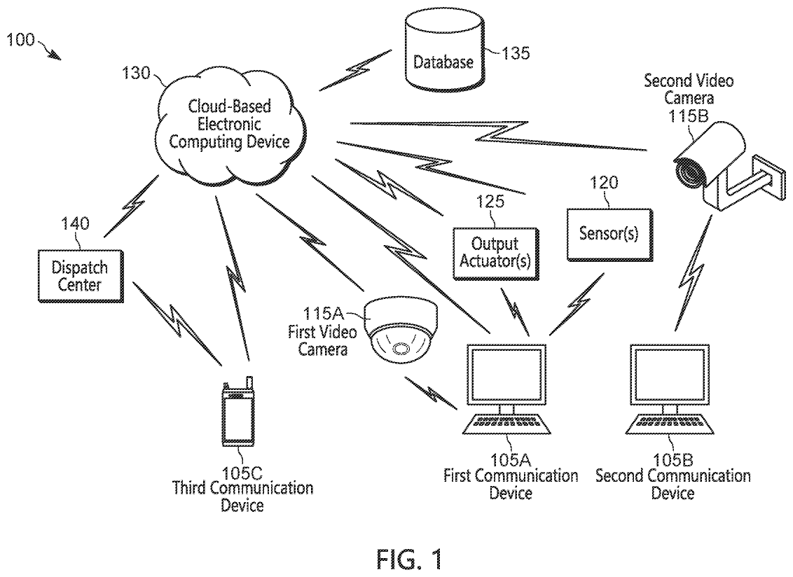

FIG. 1 is a diagram of a communication system 100 according to one example embodiment. In the example illustrated, the communication system 100 includes a first communication device 105A, a second communication device 105B, and a third communication device 105C. The communication devices 105 may be configured to be operated by a user (e.g., a security officer, a public safety officer, managers, supervisors, foremen, crisis response coordinators, or the like). As illustrated by the example users listed immediately above, the user may be any decision-making person associated with a communication device 105 that receives information about a current event. Each communication device 105 may be associated with a specific user for a limited period of time (e.g., during a work shift) or for the lifetime of the communication device 105. For example, a public safety officer such as a police officer may be assigned a specific portable radio device for the lifetime of the portable radio device. As another example, a security officer at a museum or a foreperson at a job site may log into a desktop computer at the beginning of their work shift such that the security officer or the foreperson is associated with the desktop computer during their work shift.

While numerous examples/use cases herein refer to security officers and public safety officers, the disclosed systems, methods, and devices may be applied in any other situation/context in which it is desirable to provide information to a communication device 105 of a person to allow them to evaluate certain events/alarms that are detected by video cameras 115, sensors 120, and/or other measuring devices. For example, non-limiting examples of additional professions/contexts in which the disclosed systems, methods, and devices may be applied include usage by a cyber defense engineer, a network security analyst, a seismologist, a power grid supervisor, a traction network supervisor, and/or the like. The surveillance system explained herein may be used by any one of the above-noted professionals to monitor a work area or other area. In other instances, the surveillance system explained herein may be used by non-professionals to monitor a desired area (e.g., residential home/property monitoring).

As indicated by the above examples and by FIG. 1, in some instances, the communication device 105 is a handheld communication device, for example, a mobile telephone or other portable communication device, mobile vehicular radio, laptop computer, tablet computer, smart watch or other smart wearable, or may be another user equipment (UE) device configured to communicate with other devices included in the communication system 100. In some embodiments, the communication device 105 is a desktop computer located at a security site.

As indicated in FIG. 1, the communication devices 105 may be communicatively connected to each other and/or to other devices in the communication system 100 via a wired connection and/or a wireless connection. In some instances, the communication devices 105A and 105B are communicatively coupled to one or more video cameras 115, one or more sensors 120, one or more output actuators 125, and/or a cloud-based electronic computing device 130. In some instances, the communication devices 105A and 105B are communicatively coupled to the one or more video cameras 115, the one or more sensors 120, the one or more output actuators 125, and/or the cloud-based electronic computing device 130 to form a surveillance system to monitor a certain area (e.g., a museum, a stadium, a residence, and/or the like).

In the following description, when explaining how a single video camera 115 functions, a reference to video camera 115 may be used. However, as indicated in FIG. 1, it is not necessary that the video cameras 115A and 115B are identical. In some embodiments, the video cameras 115 are part of a surveillance system that monitors a security site such as the inside and/or outside of a building, an outdoor property, a construction site, and/or the like. The video cameras 115 are merely examples. The surveillance system may include any one or more of a number of different types of video cameras including, but not limited to, pan-tilt-zoom (PTZ) cameras (see second video camera 115B), ceiling-mounted or wall-mounted cameras (see first video camera 115A), indoor or outdoor cameras, floodlight cameras, doorbell cameras, fisheye cameras, and/or the like.

In some instances, one or more video cameras 115 provides video data to the cloud-based electronic computing device 130 to be analyzed to determine whether to transmit an alarm notification to a communication device 105. For example, the cloud-based electronic computing device 130 may use image/video analytics to identify a banned object (e.g., a gun) in a video captured in a museum and, in response thereto, may transmit an alarm notification to a communication device 105.

Similar to the video cameras 115, in some instances, the sensor(s) 120 provides data to the cloud-based electronic computing device 130 to be analyzed to determine whether to transmit an alarm notification to a communication device. For example, the sensor(s) 120 may include a smoke detector, a motion sensor, a light sensor, a magnetic sensor that detects the presence and absence of another object such as whether a door is opened or closed, and/or the like. In some instances, the cloud-based electronic computing device 130 may transmit an alarm notification to a communication device 105 in response to determining that the data from the sensor(s) 120 indicates an unexpected condition or an emergency condition (e.g., a door being opened when it should be closed, detection of motion in a secure area where motion is not expected, detection of smoke, etc.).

In some instances, the output actuator(s) 125 are devices that the cloud-based electronic computing device 130 controls to take a security action. For example, output actuators 125 may be present on one or more doors within a building to allow the cloud-based electronic computing device 130 to lock or unlock the doors of the building remotely, for example, in response to a detected security event. As another example, output actuators 125 may be associated with certain highly valuable items (e.g., paintings in a museum) to cause safety/security glass to move to cover or protect the highly valuable items in response to a remote command received from the cloud-based electronic computing device 130. Specifically, safety glass may move to cover a valuable painting or sculpture in response to a user input prompted by the cloud-based electronic computing device 130 detecting a security event and/or detecting smoke that may damage the painting or sculpture.

In some instances, the cloud-based electronic computing device 130 communicates with a database 135 that stores information associated with previous events detected by the components of the surveillance system. The cloud-based electronic computing device 130 may transmit information about a current event (e.g., including sensor information, video data, information entered by a user regarding handling of the event such as whether the detected event was a false alarm, etc.) to the database 135 for storage and future reference. The cloud-based electronic computing device 130 may reference information regarding previous events in the database 135 to provide improved notifications regarding a current event to a communication device 105 as explained in greater detail herein.

In some instances, the cloud-based electronic computing device 130 includes one or more electronic processors located at the same location or at distributed locations. For example, the cloud-based electronic computing device 130 may include one or more servers remote from a certain area that is being monitored by the surveillance system. The one or more servers may be configured to analyze and/or store video footage obtained by the video cameras 115. In some instances, one or more communication devices 105 and/or a local server (not shown) may additionally or alternatively analyze and/or store video footage obtained by the video cameras 115. The cloud-based electronic computing device 130 may include an analytics engine configured to perform video/data analytics on video footage and on sensor data and/or execute at least some of the methods described herein. In some embodiments, the cloud-based electronic computing device 130 includes a software application that controls other integrated or separate cloud-based processing devices to perform certain tasks. One or more elements of the cloud-based electronic computing device 130 may be implemented as a discrete network element on a dedicated hardware, as a software instance running on dedicated hardware, or as a virtualized function instantiated on an appropriate platform, e.g., dedicated hardware or a cloud-based computing infrastructure.

In the present disclosure, the cloud-based electronic computing device 130 is described as the primary device that (i) receives data from monitoring devices such as the video cameras 115 and/or sensor(s) 120, (ii) provides information to the communication devices 105, and/or (iii) controls output actuator(s) 125. However, in some instances, the communication device 105, a local server (not shown), and/or electronic processors in the monitoring devices themselves may additionally or alternatively perform any one or a combination of actions (i) through (iii) mentioned above. In other words, an electronic computing device that performs the methods described herein may include any one or a combination of electronic processors located within a single device or distributed among various devices in the communication system 100. Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations. To reiterate, those electronic processors and processing may be distributed.

FIG. 1 does not necessarily illustrate all communication paths that exist within the communication system 100. For example, a communication device 105 may communicate with the database 135 without using the cloud-based electronic computing device 130 as an intermediary. As another example, one or more of the monitoring devices 115 and 120 may communicate data directly to the database 135 without using the cloud-based electronic computing device 130 as an intermediary.

With respect to the left portion of FIG. 1, the third communication device 105C, a dispatch center 140 (e.g., one or more dispatch consoles/communication devices 105 at the dispatch center 140), and/or the cloud-based electronic computing device 130 may be communicatively coupled with each other to form a dispatch system such as public safety communication system. FIG. 1 shows the cloud-based electronic computing device 130 as shared between the surveillance system (right portion of FIG. 1) and the dispatch system (left portion of FIG. 1). In other instances, the surveillance system and the public safety system may be separate and may have separate cloud-based electronic computing devices 130 and/or separate databases 135.

In some instances, the dispatch center 140 may provide an assignment to a public safety officer associated with the third communication device 105C to handle a current event. For example, a dispatcher may assign a certain public safety officer to handle a reported current event based on availability and proximity of public safety officers. The dispatch center 140 may transmit a notification of assignment of the reported current event to the third communication device 105C via the cloud-based electronic computing device 130. In some instances, the cloud-based electronic computing device 130 communicates with the database 135 that stores information associated with previous events that were reported to the dispatch center 140. In some instances, the database 135 may include multiple databases such that stored surveillance information is stored separately from stored public safety event information. The cloud-based electronic computing device 130 may transmit information about a reported current event (e.g., location, time of day, date, event/incident type, etc.) to the database 135 for storage and future reference. The cloud-based electronic computing device 130 may reference information regarding previous events in the database 135 to provide improved notifications regarding the reported current event to the communication device 105C as explained in greater detail herein.

In a similar manner as described previously herein, although the cloud-based electronic computing device 130 is illustrated as separate from the dispatch center 140 in FIG. 1, the electronic processor(s) that make up an electronic computing device that performs the methods described herein may be included on any one or a combination of devices within dispatch system (e.g., the cloud-based electronic computing device 130, the dispatch center 140 (e.g., on a dispatch console/communication device 105), and/or the third communication device 105C).

As illustrated in FIG. 1, the devices in the communication system 100 are configured to communicate with each other (for example, by sending and receiving radio signals directly to and from each other and/or via a base station of a communication network). In an example embodiment, the communication network that allows for bidirectional communication between devices in the communication system 100 is a 5G/LTE communication network. However, other communication networks may also be used. The communication network may include wireless and wired portions. All or parts of the communication network may be implemented using various existing or future-developed specifications or protocols. In some embodiments, the communication network is implemented using a direct-mode, conventional, or trunked land mobile radio (LMR) standard or protocol, for example, a Digital Mobile Radio (DMR) standard defined by the European Telecommunications Standards Institute (ETSI), a Project 25 (P25) standard defined by the Association of Public Safety Communications Officials International (APCO), a Terrestrial Trunked Radio (TETRA) standard defined by the European Telecommunications Standards Institute (ETSI), or other LMR radio protocols or standards. In some embodiments, the communication network implements the Long Term Evolution (LTE) (including LTE-Advanced or LTE-Advanced Pro compliant with, for example, the 3GPP TS 36 specification series), or the 5G (including a network architecture compliant with, for example, the 3GPP TS 23 specification series and a new radio (NR) air interface compliant with the 3GPP TS 38 specification series) standard, among other possibilities, and over which multimedia broadcast multicast services (MBMS), single site point-to-multipoint (SC-PTM) services, or Mission Critical Push-to-talk (MCPTT) services may be provided, or over which an open mobile alliance (OMA) push to talk (PTT) over cellular (OMA-PoC), a voice over IP (VOIP), or a PTT over IP (PoIP) application may be implemented. The communication network may also include future developed networks. In some embodiments, the communication network may also include a combination of the networks mentioned.

In some embodiments, at least some of the local devices 105, 115, 120, 125 in the surveillance system may be configured to communicate directly with each other using a communication channel or connection that is outside of the 5G/LTE communication network. In some embodiments, the local devices 105, 115, 120, 125 may communicate with each other via wired or wireless connections, for example, over a local network that may be similar to the communication network described immediately above. In some embodiments, the local network may be a local area network (LAN). In some embodiments, at least some of the local devices 105, 115, 120, 125 may communicate directly with each other when they are within a predetermined distance from each other using short-range communication mechanisms such as Bluetooth® or WiFi communication links.

FIG. 1 illustrates only one example embodiment of the communication system 100. In other embodiments, the system 100 may include more or fewer components and may perform functions that are not explicitly described herein. For example, the communication system 100 may include additional communication devices 105, video cameras 115, databases 135, and dispatch centers (or dispatch center communication devices) 140. As another example, while shown as a single entity in FIG. 1, the cloud-based electronic computing device 130 may include numerous separate cloud-based components.

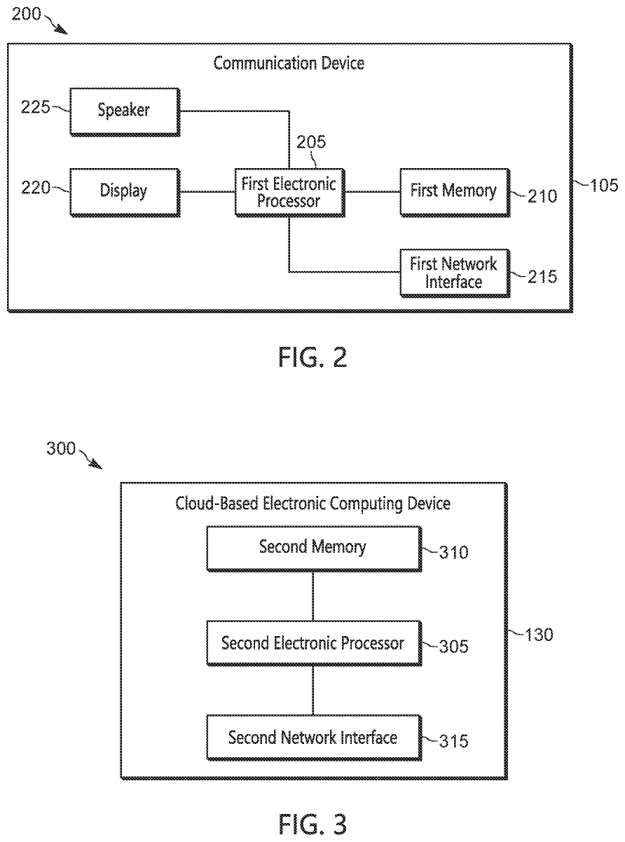

FIG. 2 is a block diagram 200 of a communication device 105 of the communication system 100 according to one example embodiment. In the example shown, the communication device 105 includes a first electronic processor 205 (for example, a microprocessor or another electronic device). The first electronic processor 205 may include input and output interfaces (not shown) and be electrically connected to a first memory 210, a first network interface 215 including a transceiver and an antenna, a display 220, and a speaker 225.

The first memory 210 includes read only memory (ROM), random access memory (RAM), other non-transitory computer-readable media, or a combination thereof. The first electronic processor 205 is configured to receive instructions and data from the first memory 210 and execute, among other things, the instructions. In particular, the first electronic processor 205 executes instructions stored in the first memory 210 to perform at least some of the methods described herein.

The first network interface 215 may send and receive data to and from other devices in the communication system 100 (for example, directly and/or over the communication network described previously herein). For example, the first network interface 215 includes a wireless Radio Frequency (RF) communication transceiver and an antenna, for example a RF antenna, for wirelessly communicating with other devices. Alternatively or in addition, the first network interface 215 may include a connector or port for receiving a wired connection to one or more communication networks, such as an Ethernet cable. The first electronic processor 205 may communicate information (e.g., user inputs received on the communication device 105, etc.) through the first network interface 215 (for example, to the cloud-based electronic computing device 130, the output actuator(s) 125, and/or the like). Similarly, the first electronic processor 205 may output data received via the first network interface 215 (for example, video/audio footage/data from a video camera 115, sensor data from the sensor(s) 120, alarm notifications generated by the cloud-based electronic computing device 130, information regarding previous events that was retrieved from the database 135, and/or the like) using the speaker 225, the display 220 (which may include a touchscreen), or a combination thereof. In some embodiments, a user interface of the communication device 105 may include one or more output devices that provide output to a user (e.g., the display 220, the speaker 225, a haptic device that provides vibrations, etc.) and one or more input devices that receive input from the user (e.g., a microphone, the display 220 embodied as a touchscreen, etc.).

In some embodiments, the communication device 105 may include fewer or additional components in configurations different from that illustrated in FIG. 2. For example, in some embodiments, the communication device 105 also includes one or more of a microphone, a camera, and a location component (for example, a global positioning system (GPS) receiver). As another example, the first electronic processor 205 may include a plurality of electronic processors that are distributed within the communication device and that together each perform one or more functions. In some embodiments, the communication device 105 performs at least one additional functionality than the functionality described herein.

In some embodiments, the first network interface 215 may be configured to communicate over one or more different wireless communication networks or using different wireless communication protocols. For example, the network interface 215 may include multiple RF transceivers and/or multiple RF antennas to allow for communication over different types of wireless communication networks/protocols. In some embodiments, the network interface 215 includes multiple RF transceivers to allow for communication over different types of wireless communication networks/protocols but each transceiver may be configured to use the same RF antenna to engage in such communications. In some embodiments, a single RF transceiver may be configured to allow for communication over different types of wireless communication networks/protocols.

FIG. 3 is a block diagram 300 of the cloud-based electronic computing device 130 of the communication system 100 according to one example embodiment. The components shown in FIG. 3 are similar to the like-named components described above with respect to the communication device 105 and perform similar general functions. Accordingly, in some embodiments, the cloud-based electronic computing device 130 may include at least some similar components and functionality (e.g., data communication capabilities) as the communication device 105. In some embodiments, the network interface 315 is configured to communicate with the communication devices 105, with monitoring devices 115, 120, with the output actuator(s) 125, with the database 135, with the dispatch center 140, and/or with other devices of the communication system 100 to receive, store, and transmit information (e.g., captured video footage/data of a current event from video cameras 115 and sensor(s) 120, information about previous events stored in the database 135, etc.).

In some embodiments, the communication device 105 provides an input/output interface for the cloud-based electronic computing device 130 (e.g., to allow a user to access information stored on the cloud-based electronic computing device 130 or indicate information that is to be stored by the cloud-based electronic computing device 130, for example, in the database 135). In some embodiments, the functionality of the cloud-based electronic computing device 130 described herein may be performed by the communication device 105 and/or other devices in the communication system 100 such that a distinct cloud-based electronic computing device 130 may not be present in the communication system 100.

In some embodiments, the cloud-based electronic computing device 130 may include fewer or additional components in configurations different from that illustrated in FIG. 3. For example, the second electronic processor 305 may include a plurality of electronic processors that are distributed within cloud computing devices and that together each perform one or more of the steps of the methods described herein. In some embodiments, the cloud-based electronic computing device performs at least one additional functionality than the functionality described herein.

As explained previously herein, there is a technological problem with surveillance systems and dispatch systems causing increased user error due to cognitive and unconscious bias by providing similar alarm notifications, incident assignments, etc. To address this technological problem, one or more devices of the communication system 100 may perform the methods explained below to provide differentiating information between a current event to which a user is assigned and previous similar events to which the user was assigned.

The methods explained below to address the above-noted technological problem assume (i) that an event (e.g., a potential security event, detection of an alarm, a public safety incident, etc.) has been detected and/or reported and (ii) that handling/investigation of the event is assigned to a certain user (e.g., based on work shift assignment, based on proximity to the event, etc.). Accordingly, the detection and/or reporting of an event is not the primary focus of this disclosure. Similarly, the assignment of a certain user to handle/investigate the event is not the primary focus of this disclosure. Rather, the methods described herein primarily focus on analyzing a current event and a current assignment in view of previous similar events to provide an enhanced user experience with respect to information provided to an assigned user regarding the current event. As indicated herein, the enhanced user experience reduces or eliminates bias in the decision-making of the user handling the current event by specifically highlighting differences (or a single difference) in the current event with respect to seemingly identical or similar previous events that were handled by the user (or by other users).

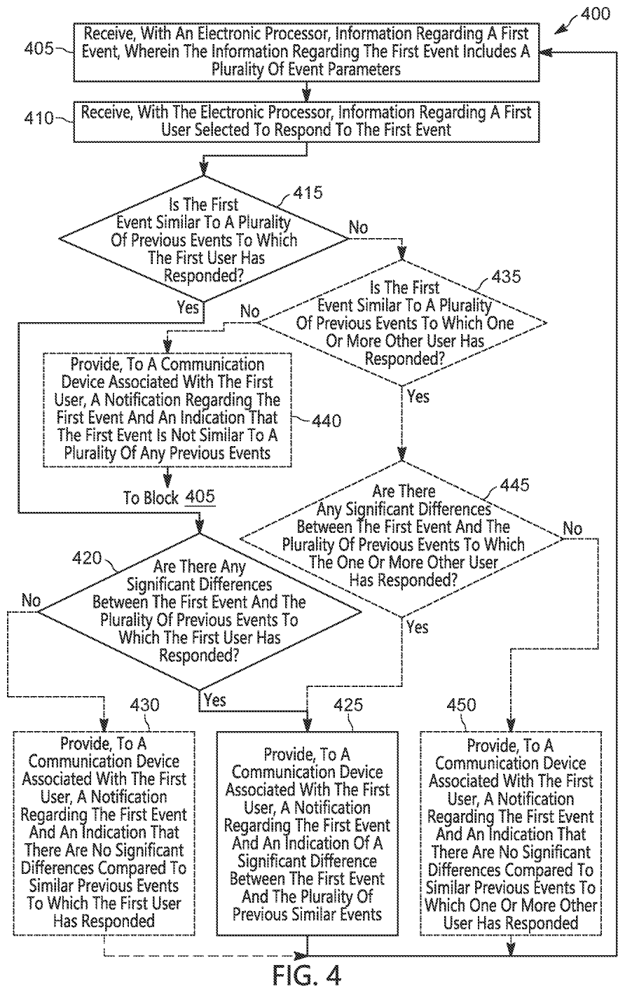

FIG. 4 is a flowchart of a method 400 of providing differentiating information included in similar events according to one example embodiment. While a particular order of processing steps, message receptions, and/or message transmissions is indicated in FIG. 4 as an example, timing and ordering of such steps, receptions, and transmissions may vary where appropriate without negating the purpose and advantages of the examples set forth in detail throughout the remainder of this disclosure.

In some embodiments, the method 400 is performed by the cloud-based electronic computing device 130, and, specifically, the second electronic processor 305, which may include one or more distributed electronic processors. In some embodiments, the method 400 is performed by the communication device 105 and/or a local server (i.e., the respective electronic processor 205 of each device). In some embodiments, the method 400 is performed by any combination of the cloud-based electronic computing device 130, the communication device 105, a local server, and other devices (e.g., an electronic processor build-in to a camera 115). Regardless of which specific devices perform all or portions of the method 400, an entity performing the method 400 may be referred to as an electronic computing device. In other words, the electronic computing device may include one or more electronic processors within the same device or distributed at different locations/devices. For example, the electronic computing device may be located in the cloud (e.g., the cloud-based electronic computing device 130), at a security site (e.g., communication device 105 and/or a local server), or a combination of both. For the sake of readability, the below description of the method 400 assumes that the second electronic processor 305 of the cloud-based electronic computing device 130 performs the method 400, for example, (i) after receiving video footage captured by a plurality of video cameras 115 and/or after receiving sensor data from the sensor(s) 120, and/or (ii) after receiving a dispatched assignment from the dispatch center 140.

An instance of the method 400 begins at block 405, where the second electronic processor 305 of the cloud-based electronic computing device 130 receives information regarding a first event. In some instances, the first event may be based on an alarm associated with one or more sensors 120 being triggered (e.g., a smoke alarm, a motion detector, etc.). In some instances, the first event may have been detected using image/video analytics, for example, to determine that a person in a museum is carrying a banned object (e.g., a gun) or to determine that a fugitive was recognized at a certain location (e.g., using facial recognition). In some instances, the first event may be a public safety incident (e.g., a robbery, a fire, a request for a wellness check, etc.) that was reported to a dispatch center 140 by a caller.

In some instances, the second electronic processor 305 may receive information regarding the first event by determining, itself, the information regarding the first event based on raw data that is provided by the video cameras 115 and/or the sensor(s) 120 (e.g., using a video/data analysis engine). The information regarding the first event may include a plurality of event parameters of the first event. In some instances, the plurality of event parameters may be stored in metadata by the second electronic processor 305 or by another device (e.g., a dispatch console at the dispatch center 140) that analyzed and/or received input data to identify the first event. The plurality of event parameters may include a date of the event, a time of the event, a triggering action that caused the first event to be detected (e.g., a sensed carbon monoxide value, an amount of time that a door was sensed to be open, etc.), image/video tags of associated images/video (e.g., tags indicating the number of people in an area, the number of vehicles in an area, tags indicating a banned object detected in a video, etc.), audio tags of associated audio (e.g., the time at which a noise was detected), an event type of the incident (e.g., fire alarm, door open detection, a specific type of public safety incident as identified by a dispatcher, etc.), images/video itself (e.g., scenes in a video), audio itself (e.g., volume information, pitch information, etc.), and/or the like. In some instances, image/video tags and/or audio tags may be categorized as a triggering action that caused the first event to be detected.

At block 410, the second electronic processor 305 receives information regarding a first user selected to respond to the first event. As indicated previously herein, in some instances, the first user selected to respond to the first event is known based on a work shift assignment and/or based on a type of the first event. For example, a surveillance system may be configured to provide notifications regarding certain events to certain individuals and/or to certain communication devices 105 that are known to be operated by certain individuals at a given time based on a work schedule. In some instances, the first user is assigned to respond to the first event (e.g., a public safety incident) by a dispatcher at the dispatch center 140. For example, in response to receiving a report regarding a current/ongoing public safety incident, the dispatcher assigns a nearby officer/user to handle the public safety incident. This assignment may be provided to the cloud-based electronic computing device 130. In some instances, the second electronic processor 305 may receive information regarding the first user selected to respond to the first event by determining the first user itself based on the information regarding the first event and/or pre-programmed information (e.g., stored in the second memory 310) regarding who should handle certain types of events at certain times.

At block 415, the second electronic processor 305 determines, based on the information regarding the first event and the information regarding the first user, whether the first event (i.e., a current/ongoing event) is similar to a plurality of (i.e., multiple) previous events to which the first user has responded. In some instances, the second electronic processor 305 determines whether the first event is similar to a plurality of previous events to which the first user has previously responded/handled by comparing each of the plurality of event parameters of the first event to a plurality of event parameters of the plurality of previous events to which the first user has responded. In some instances, the second electronic processor 305 completes this comparison by identifying a type of event of the first event and requesting and retrieving information, from the database 135, regarding previous events of the same type to which the first user responded.

In some instances, more recent previous events of the same type may be more useful to compare to the first event since these more recent previous events are more likely to influence the first user's decision-making than less recent previous events of the same type to which the first user has responded. Accordingly, in some instances, the second electronic processor 305 may request only stored recent events of the same type that were handled by the first user from within a recent time frame (e.g., two weeks, a month, six months, or the like) as long as the number (N) of such stored recent events is greater than a predetermined value (e.g., five, ten, twenty, or the like). When N is not greater than the predetermined value, the second electronic processor 305 may request and retrieve information regarding at least some previous events that are older and fall outside of the recent time frame in order to have a more complete data set for analysis. Alternatively, when N is not greater than the predetermined value, the second electronic processor 305 may determine that there is not enough data to perform an accurate assessment (e.g., not enough similar recent events to indicate that the user may have formed a bias for handling the events) and may determine (at block 415) that the first event is not similar to a plurality of previous events to which the first user has responded.

Upon receiving, from the database 135, the plurality of event parameters of each of the plurality of previous events to which the first user has responded, the second electronic processor 305 compares each of the plurality of event parameters of the first event to a plurality of event parameters of the plurality of previous events to which the first user has responded. For example, the second electronic processor 305 may be configured to determine that the first event is similar to a plurality of (i.e., more than one) previous events to which the first user has responded in response to determining that certain key event parameters of the first event are identical or within range of corresponding key event parameters of multiple previous events. For example, in addition to event type that is similar or identical based on the requested information from the database 135, the key parameters may include a triggering action that caused the events to be detected, a location of the events, a time of day of the events, and/or a day of the week of the events. As a more specific example, the second electronic processor 305 may determine that the first event is similar to a plurality of previous events to which the first user responded in response to determining that the first event and a plurality of previous events to which the first user responded were all triggered by the same motion sensor at the same location in a museum between 6 PM and 7 PM. In some instances, the second electronic processor 305 is configured to determine whether the first event is similar to the plurality of previous events to which the first user has responded in response to (i) determining that a triggering action that detected the first event is the same as a triggering action that detected the plurality of previous events to which the first user has responded (e.g., the same sensor 120 measuring a value that exceeds a threshold, the same or a similar action (e.g., a punch being thrown, a person falling, etc.) or object (e.g., a gun, a knife, a can of spray paint, another banned object, etc.) being detected in a video using video analytics, etc.), and (ii) determining that a location of the first event is the same or within a predetermined proximity as a location of the of the plurality of previous events to which the first user has responded.

In some instances, the second electronic processor 305 may be configured to determine whether the first event is similar to the plurality of previous events to which the first user has responded in response to determining that a predetermined amount of the plurality of event parameters of the first event (e.g., three, four, five, or the like) include a first value that is the same as or within a predetermined range of a second value of a corresponding event parameter of the plurality of event parameters of the plurality of previous events to which the first user has responded. For example, the second electronic processor 305 determines that the first event is similar to a plurality of previous events to which the first user has responded in response to determining that each of the events was triggered by (i) between three and five vehicles (ii) being in the same restricted area (iii) between 5 PM and 6 PM (iv) on the same day of the week. In this example, the similarity is detected based on at least four event parameters being identical or within range of each other (e.g., within a minimum-maximum range (e.g., between a minimum and maximum value of an event parameter of the set of previous similar events) or average range (e.g., within a certain threshold from an average value of an event parameter in the set of previous similar events such as within 10%, 20%, of the like)). Accordingly, if only three event parameters were identical or within a range or average of previous event parameters, the second electronic processor 305 would not have determined a similarity between the first event and the plurality of previous events to which the first user has responded.

In some instances, different instances of the method/system may be configured in different ways by different entities that implement the method/system in order to tune the determination of whether the first event is similar to a plurality of previous events to which the first user has responded. For example, each instance of the method/system may be programmed to include user-adjustable values that control how the second electronic processor 305 determines whether the first event is similar to a plurality of previous events to which the first user has responded (e.g., how many common event parameters are necessary, which event parameters are key event parameters, ranges of each event parameter that indicate a similar value (such as time ranges, ranges of amounts of people or objects in a video, etc.).

In some instances, the second electronic processor 305 is configured to determine whether the first event is similar to the plurality of previous events to which the first user has responded by analyzing the plurality of event parameters of the first event using a machine learning model that was trained using (i) a plurality of event parameters of previous events and (ii) indications of whether the previous events were similar to each other.

In some instances, the determination made at block 415 is indicative of a likelihood that the first user will be biased regarding a decision on how to handle the first event. For example, when many recent previous events are determined to be similar to the first event and these recent previous events were all or mostly handled in the same manner (e.g., identified as a false alarm), the first user may be more likely to be biased to think that the similar first event is also a false alarm. As another example, if the previous events are less recent, less frequent, or were handled in a different manner than each other, the first user may be less likely to be biased to think that the first event is similar to these previous events. Accordingly, as indicated above, at block 415, the second electronic processor 305 may take similarity of event parameters into account as well as the recency and frequency/amount of previous events when determining whether the first event is similar to a plurality of previous events.

In response to determining that the first event is similar to the plurality of previous events to which the first user has responded (at block 415), the method 400 proceeds to block 420. At block 420, the second electronic processor 305 determines whether there are any significant differences between the first event and the plurality of previous events to which the first user has responded by comparing each of the plurality of event parameters of the first event to corresponding event parameters of the plurality of event parameters of the plurality of previous events to which the first user has responded.

In some instances, a significant difference may be identified in response to the second electronic processor 305 determining that one or more key event parameter values (e.g., a location of the event, a time of day of the event, a day of the week of the event, a duration of the event, etc.) of the first event is different than or outside of a minimum-maximum range (e.g., outside of a minimum and maximum value of an event parameter of the set of previous similar events) or average range (e.g., outside a certain threshold from an average value of an event parameter in the set of previous similar events such as within 10%, 20%, or the like from the average value) of corresponding key event parameter values of the plurality of previous events. In some instances, a significant difference may be identified in any event parameter regardless of whether the event parameter is predetermined to be a key event parameter. In some instances, the second electronic processor 305 is configured to determine whether there are any significant differences between the first event and the plurality of previous events to which the first user has responded by comparing each of the plurality of event parameters of the first event to corresponding event parameters of the plurality of event parameters of the plurality of previous events to which the first user has responded by determining whether an event parameter value of the first event is outside of a predetermined range. In some instances, the predetermined range is based on event parameter values of a corresponding event parameter of the plurality of previous events. For example, the predetermined range may be an average time/duration calculated from the plurality of previous events, a time range in which similar events have been historically received (e.g., between 8 PM and 10 PM), and/or the like.

In some instances, through execution of blocks 415 and 420, the second electronic processor 305 may determine that there is a significant difference between the first event and a plurality of previous similar events. For example, when the first event was determined to be similar to a plurality of previous event handled by the first user (at block 415) because the first event and the plurality of previous event were each triggered because (i) between three and five vehicles (ii) were in the same restricted area (iii) on the same day of the week, the second electronic processor 305 may determine that there is a significant difference between the first event and the plurality of previous events in response to determining that each of the plurality or previous events occurred between 5 PM and 6 PM while the first event is occurring at 8 PM. Other examples are explained in different use cases.

In a similar manner as explained previously with respect to block 415, in some instances, different instances of the method/system may be configured in different ways by different entities that implement the method/system in order to tune the determination of whether there are any significant differences between the first event and the plurality of previous events to which the first user has responded. For example, each instance of the method/system may be programmed to include user-adjustable values that control how the second electronic processor 305 determines there are any significant differences between the first event and the plurality of previous events to which the first user has responded (e.g., how a threshold range/value is determined from the event parameters of the previous events, ranges of each event parameter that indicate a significantly different value (such as time ranges, ranges of amounts of people or objects in a video, which event parameters are key event parameters, etc.).

In some instances, the second electronic processor 305 is configured to determine whether there are any significant differences between the first event and the plurality of previous events to which the first user has responded by comparing each of the plurality of event parameters of the first event to corresponding event parameters of the plurality of event parameters of the plurality of previous events to which the first user has responded using a machine learning model that was trained using (i) a plurality of event parameters of previous events and (ii) indications of whether each event parameter value of the plurality of event parameters of the previous events is significantly different than event parameter values of corresponding event parameters of other previous events.

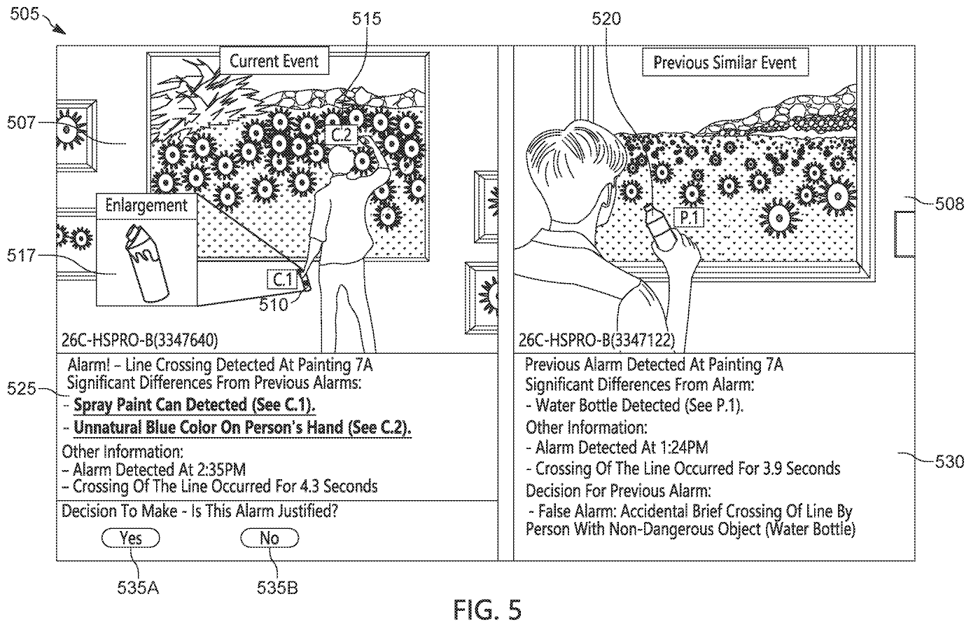

In response to determining that there is a significant difference (at least one significant difference) between the first event and the plurality of previous events to which the first user has responded (at block 420), the method 400 proceeds to block 425. At block 425, the second electronic processor 305 provides, to a communication device 105 associated with the first user, a notification regarding the first event and an indication of the significant difference. In some instances, the second electronic processor 305 transmits instructions to the communication device 105 (e.g., an application running on the communication device 105) that causes the communication device 105 to output the notification regarding the first event and the indication of the significant difference. In other words, the indication of the significant difference is output via an output device (e.g., the display 220, the speaker 225, and/or the like) of the communication device 105 for consumption by the first user. In some instances, the indication of the significant difference is output via the output device by at least one of a group consisting of (i) displaying information regarding the significant difference on the display 220 as text in a manner that is distinguished from other displayed text (e.g., as shown in FIG. 5), (ii) displaying, on the display 220, an image or video with an annotation or other distinguishing feature that emphasizes the significant difference (e.g., as shown in FIG. 5), (iii) displaying a first selectable feature (e.g., a link) on the display 220 that, in response to be selected by the first user, outputs audio regarding the significant difference via the speaker 225, (iv) displaying a second selectable feature (e.g., a link) on the display that, in response to be selected by the first user, emphasizes an area in an image or video to highlight the significant difference or causes the display 220 to display additional information about the significant difference (e.g., in a new pop-up window), and (v) combinations thereof.

In some instances, the indication of the significant difference includes simultaneously displaying, on the display 220 of the communication device 105, a significantly different event parameter of the first event and a corresponding event parameter of one or more of the plurality of previous events. For example, FIG. 5 illustrates a significant difference between event parameter values in text form and as an annotated image/video as explained in greater detail below with respect to a second use case. Simultaneously displaying a significantly different event parameter value of the first event and a corresponding event parameter value of one or more of the plurality of previous events may allow the first user to compare the significantly different event parameter of the first event with a corresponding event parameter of a previous event from the plurality of previous events. For example, event parameters such as values (e.g., time of day, duration, sensor values, etc.), images/videos, sounds (or buttons that can be selected to provide sounds), etc. may be displayed side-by-side to allow the first user to compare them and decide how to handle the first event. The indication of the significant difference may be output via an output device of the communication device 105 in other manners as well.

In some instances, the second electronic processor 305 also provides information (e.g., in text) regarding the similarities between the first event and the plurality of previous events to which the first user responded. However, these similarities may not be emphasized/highlighted such that the indication of the significant difference and its corresponding information are emphasized/highlighted with respect to any information regarding similarities.

In some instances, the second electronic processor 305 is configured to receive a user input from the communication device 105 that indicates whether the second electronic processor 305 should take one or more security actions with respect to the first event. For example, the user input is received by the communication device 105 in response to a prompt regarding the first event that is displayed on the display 220 of the communication device 105 along with the indication of the significant difference. The communication device 105 may transmit an instruction to the second electronic processor 305 of the cloud-based electronic computing device 130 to cause the second electronic processor 305 to take one or more security actions. For example, a security action may include controlling the output actuator(s) 125 in a certain manner (e.g., to lock or unlock doors, to lower protective/security glass, etc.) and/or providing a notification to a public safety agency (e.g., calling the police). In some instances, the communication device 105 may take one or more security actions in response to receiving the user input that indicates that the one or more security actions should be taken.

In some instances, the second electronic processor 305 is configured to receive, from the communication device 105, user feedback information (that was received via a user input on the communication device 105) that indicates which event parameters of the plurality of the event parameters of the first event were useful to aid the first user in making a decision regarding how to handle the first event. The second electronic processor 305 may be configured to update the algorithm and/or machine learning model used to identify significant differences between a current event and previous similar events based on the user feedback information. For example, the machine learning model may be re-trained or improved by factoring in user feedback information that is provided with respect to events analyzed by the machine learning model.

In some instances, the communication device 105 may receive a user input that indicates that the user desires additional information about the first event and/or the plurality of previous events in order to make their decision regarding how to handle or classify the first event. For example, the user input may indicate that the user desires video data obtained by another video camera 115 during the first event and/or one or more of the previous similar events. The communication device 105 may transmit this request to the cloud-based electronic computing device 130. The cloud-based electronic computing device 130 may provide the requested additional information to the communication device 105 for output to the user. In some instances, the second electronic processor 305 of the cloud-based computing device 130 updates the algorithm and/or the machine learning model used to identify significant differences between a current event and previous similar events based on the additional information requested by the user (e.g., to attempt to improve the machine learning model).

Through execution of blocks 405 through 425, the method 400 provides differentiating information included in similar detected/reported events in order to reduce or eliminate bias in the decision-making of the user handling a current event. As described previously herein, the goal of highlighting/emphasizing this differentiating information is to call the user's attention to these differences to encourage the user to take these differences into account when determining how to handle the current event that may initially appear to be identical to previous events. Such highlighting addresses the above-noted technological problem by providing an improved user interface/user experience that results in better decision-making regarding the handling of current events by users/officers. A number of example use cases are explained below to help understand example situations in which the method 400 may be applied.

In a first example use case, a communication device 105 of a certain security officer may receive multiple alarm notifications per work shift about employees entering a restricted area (e.g., opening a door to a restricted area as sensed by a sensor 120). For most instances of this alarm notification, the employees realize that they have accidentally entered a restricted area and close the door in three seconds or less. Thus, the security officer usually dismisses the alarm notification by indicating that the person who opened the door did not actually enter the restricted area. For a current event that is triggered by the same sensor due to the same door being opened, the second electronic processor 305 identifies these key event parameter similarities (as well as the current event occurring in the same time range as the previous similar events) but also identifies several significant differences. For example, the second electronic processor 305 determines that the door is opened for longer than five seconds in the current event. As another example, the second electronic processor 305 determines that in previous similar events, analysis of video data indicates that there is usually only one person present but, in the current event, analysis of video data indicates that there are multiple people present.

Accordingly, when providing the alarm notification to the communication device 105 of the security officer, the second electronic processor 305 indicates that the door has been opened for longer than in previous similar events and that the number of people at the event location is greater than in previous similar events. In some instances, the communication device 105 may display these significant differences in a highlighted/emphasized manner on the display 220 of the communication device 105. For example, these event parameters that have significant differences may be displayed in bolded, underlined, and/or highlighted text and/or the like. In some instances, the average value or the minimum-maximum range of the event parameters from the previous similar events may be displayed (e.g., in brackets) to allow the first user to compare the event parameters of the current event to the event parameters of the previous similar events.

In some instances, the second electronic processor 305 may transmit and the communication device 105 may display an image of a scene of the current event with tagged objects/portions related to the significant difference(s) (e.g., tagging of the people in the image) and an image of a scene of one or more previous similar events. Such a side-by-side comparison of images from two different events with tagging of objects/portions related to the significant difference(s) may allow the first user to compare the two events to make a better decision regarding how to handle the current event.

Due to the emphasized significant differences between the current event and the plurality of previous similar events, the security officer is less likely to react to the current event in a biased manner (i.e., assume that this alarm notification is the same as the many other similar alarm notifications they received from the same sensor) and instead further investigate the current event based on the emphasized significant differences. For example, the current event may relate to actual trespassing into the restricted area by a group of non-employees that are attempting to steal information.

In a second example use case, a communication device 105 of a certain security officer may receive multiple alarm notifications per work shift about visitors of a museum crossing a line that indicates a distance from which visitors should stay away from a valuable painting (e.g., as detected using video analysis of one or more video cameras 115 that monitor the area where the painting is located). For most instances of this alarm notification, the visitor realizes that they have accidentally cross the line and they move back to get behind the line. Thus, the security officer usually dismisses the alarm notification by indicating that the visitor entered the restricted area accidentally and has since left the restricted area. For a current event that is triggered by video analytics due to the same line being crossed, the second electronic processor 305 identifies these key event parameter similarities but also identifies a significant difference. For example, using video analytics, the second electronic processor 305 determines that the person who crossed the line is holding a can of spray paint whereas in previous similar events the people who crossed the line were not holding anything or were holding a water bottle. Additionally, using video analytics, the second electronic processor 305 may determine that the person who crossed the line has a large portion of their hand that is an unnatural color (e.g., blue) whereas in previous similar events the people who crossed the line did not have unnatural colors on their hands.

Accordingly, when providing the alarm notification to the communication device 105 of the security officer, the second electronic processor 305 indicates that the person who triggered the alarm is holding an object that is not similar to the objects being held by previous people who triggered the alarm in previous events. The second electronic processor 305 may also indicate that the person who triggered the alarm has an unnatural blue color on their hand. Additionally, the second electronic processor 305 may transmit and the communication device 105 may display a first image 507 of a scene of the current event with tagged objects/portions related to the significant difference(s) (e.g., a first annotation/tagging 510 of the spray paint in the image and a second annotation/tagging 515 of the blue portion of the hand) and a second image 508 of a scene of one or more previous similar events (e.g., including a third annotation/tagging 520 of a water bottle in the image). For example, FIG. 5 illustrates an example graphical user interface (GUI) 505 that may be displayed on the display 220 of the communication device 105. Such a side-by-side comparison of images from two similar events with tagging of objects/portions related to the significant difference(s) may allow the first user to compare the two events to make a better decision regarding how to handle the current event. As indicated in FIG. 5, in some instances, in response to an annotated/tagged object 510, 515, 520 being selected via user input, an enlargement 517 of the selected object may be shown.

As indicated in FIG. 5, other information about the current event and one or more of the previous similar events (e.g., other event parameter values) may be shown on the (GUI) 505 in textboxes 525 and 530. For example, the textbox 525 may include an indication of the significant differences in text that is emphasized (e.g., bolded and underlined) to stand out from other information. As another example, the textbox 530 may include text that explains how one or more of the previous similar events was handled and whether the one or more previous similar events was a false alarm. In some instances, textboxes similar to those of textboxes 525 and 530 may be displayed on the GUI 505 without displaying the images 507, 508 (e.g., for events where video data is not available or not particularly useful to deciding how to handle the event).

In some instances, the GUI 505 may not initially display the images 507, 508 or any other images but may display one or more selectable features (e.g., links) that correspond to one or more images. In such instances, in response to receiving a user input that selects one of the links, the first electronic processor 205 of the communication device 105 may control the GUI 505 to display an image associated with the selected link. Accordingly, the user is able to select which images regarding which event parameters/information are displayed. For example, the “see C.1” text in the textbox 525 may be a link that, when selected via user input, causes the image 507 to be displayed on the GUI 505. In some instances, selection of such a link causes the communication device 105 to highlight the linked object 510 in the image 507 (e.g., by creating a colored frame around the object 510), crop the image 507 to zoom in on the linked object 510, create an enlargement 517 of the linked object 510, open a new window that includes additional text, audio, and/or visual information about the linked object 510, and/or the like.

As shown in the textbox 525 of FIG. 5, in some instances, the GUI 505 includes a prompt that asks the first user to determine whether the alarm notification is justified (i.e., a true alarm for which a security action should be taken or a false alarm for which a security action should not be taken). User-selectable buttons 535A, 535B may be provided on the GUI 505 to receive a user input from the first user. As indicated previously herein, the communication device 105 may transmit the user input to the cloud-based electronic computing device 130 for data logging purposes and/or to improve the algorithm or machine-learning model that identifies significant differences. Additionally, in some instances, in response to the “Yes” user-selectable button 535A being selected, the communication device 105 displays one or more additional prompts that ask if the first user would like to initiate a security action such as controlling an output actuator 125 to lower security glass in front of the painting. Another additional security action that may be selected by the security officer is activating video analysis of video cameras 115 throughout the building to determine whether the person with spray paint can entered the museum alone and/or to determine whether anyone else in the museum is also holding a spray paint can in their hand. The result of such analysis may be provided to the communication device 105 to inform the security officer of potential related threats.

As described previously herein, the communication device 105 may also receive user inputs including user feedback data (e.g., in response to prompts) that indicate which information (i.e., event parameters) were most useful for the security officer to decide whether the alarm notification was justified. Such user feedback data may be used to update and re-train one or more algorithms (e.g., machine learning models/algorithms) that determine similarities and/or significant differences between events.

Due to the emphasized significant differences between the current event and the plurality of previous similar events in the second use case, the security officer is able to quickly realize that the current event is not a false alarm even though numerous previous similar events were false alarms. In other words, the security officer is less likely to react to the current event in a biased manner (i.e., assume that this alarm notification is the same as the many other similar alarm notifications they received about the same line crossing near the same painting) and instead further investigate the current event based on the emphasized significant differences.

In a third example use case, a communication device 105 of a certain security officer may receive multiple alarm notifications per work shift about movement detected near a ventilation duct in a stadium. The video camera 115 near the ventilation duct has low resolution and is not located very close to the ventilation duct. Accordingly, the security officer has manually verified a number of alarm notifications in a row as false alarms due to the presence of a rodent that triggered a motion sensor 120. For a current event that is triggered by the same motion sensor 120 due to a remote control device attempting to bring a bomb into the stadium, the second electronic processor 305 identifies key event parameter similarities such as the same motion sensor detecting a similar object at a similar time at a similar location near the ventilation duct (and similar low resolution video of a small object near the ventilation duct) but also identifies a significant difference. For example, the second electronic processor 305 determines that the audio recorded by the video camera 115 for the current event is different than the audio from previous similar events. Specifically, the previous similar events involving a rodent included audio with intermittent squeaking noises while the current event includes audio with a steady humming at a lower pitch.

Accordingly, when providing the alarm notification to the communication device 105 of the security officer, the second electronic processor 305 indicates that while most other event parameters of the current event are similar to those of previous similar events, the audio associated with the current event is different than that of the previous similar events. In some instances, the communication device 105 may display these significant differences in a highlighted/emphasized manner on the display 220 of the communication device 105 in a similar manner as shown in FIG. 5. In this third use case, the text displayed on the GUI 505 may include selectable features (e.g., links) to the audio for each of the current event and the one or more previous similar events to allow the security officer to compare the audio from each event.

Due to the emphasized significant difference between the current event and the plurality of previous similar events, the security officer is less likely to react to the current event in a biased manner (i.e., assume that this alarm notification is the same as the many other similar alarm notifications they received from the same sensor) and instead further investigate the current event based on the emphasized significant difference. For example, the current event relates to an actual bomb threat using a remote control device trying to enter the ventilation duct.

In a fourth example use case, a communication device 105 of a certain individual with a surveillance system at the personal residence may receive multiple alarm notifications per week or per month about movement detected in their backyard. Most instances of this alarm notification are triggered by the neighbor's cat visiting the individual's dumpster to find food scraps (i.e., a false alarm). Additionally, most instances of this alarm notification occur on weekdays around 10 PM. For a current event that is triggered by the same motion sensor 120 and/or video camera 115 due to a drone being present in the backyard, the second electronic processor 305 identifies key event parameter similarities such as the same motion sensor 120 and/or video camera 115 detecting a similar-sized object at a similar location in the backyard but also identifies significant differences. For example, the second electronic processor 305 determines that the current alarm notification was triggered at 6 PM on a Saturday as opposed to around 10 PM during a weekday. As another example, the second electronic processor 305 determines that the audio recorded by the video camera 115 for the current event is different than the audio from previous similar events. Specifically, the previous similar events involving the cat included audio with intermittent cat-like noises while the current event includes audio with a steady humming at a lower pitch. The second electronic processor 305 may additionally or alternatively identify a significant difference in exact location of a detected object within the field of view of a video camera 115 (e.g., in the air versus on the ground and/or on the dumpster). In other instances, when there is a significant difference between the size of a currently detected object and previously detected objects, the second electronic processor 305 may identify a significant difference.

Accordingly, when providing the alarm notification to the communication device 105 of the security officer, the second electronic processor 305 indicates that the day of the week, the time, and the audio associated with the current event is different than those of the previous similar events. In some instances, the communication device 105 may display these significant differences in a highlighted/emphasized manner on the display 220 of the communication device 105 in a similar manner as shown in FIG. 5. In this fourth use case, the text displayed on the GUI 505 may include links to the audio for each of the current event and the one or more previous similar events to allow the individual to compare the audio from each event. Video/images of each of the current event and one or more of the previous events may also be displayed as previously described herein.

Due to the emphasized significant differences between the current event and the plurality of previous similar events, the individual is less likely to react to the current event in a biased manner (i.e., assume that this alarm notification is the same as the many other similar alarm notifications they received from the same sensor) and instead further investigate the current event based on the emphasized significant difference. For example, the current event relates to a drone invading the individual's personal space such that the individual may wish to contact police.

In a fifth example use case, a communication device 105 of a certain public safety officer (e.g., police officer, etc.) may receive multiple alarm notifications per work week or per work month regarding a wellness check of an individual at the same address at approximately the same time of day (e.g., 5 PM). Most instances of this alarm notification are triggered by the individual's family requesting the wellness check out of caution once the family member returns home from work. For a current event/incident, a neighbor calls for a wellness check because they believe that individual may have fallen in their home. A dispatcher assigns the wellness check of the individual to the same public safety officer that has performed many past wellness checks of the individual. Accordingly, the public safety officer may assume that the current wellness check is similar to the many previous wellness checks where the individual was safe and well when the officer arrived. The second electronic processor 305 identifies key event parameter similarities such as the same event/incident type for the same person at the same location but also identifies a significant difference. For example, the second electronic processor 305 determines that the current wellness check event was dispatched to the officer at 9 AM as opposed to around 5 PM.

Accordingly, when providing information about the current wellness check event to the communication device 105 of the public safety officer, the second electronic processor 305 indicates that the time of day associated with the current event is different than that of the previous similar events. In some instances, the communication device 105 may display this significant difference in a highlighted/emphasized manner on the display 220 of the communication device 105 in a similar manner as shown in FIG. 5 to attempt to capture the officer's attention and encourage them to think about the significant difference.

Due to the emphasized significant difference between the current event and the plurality of previous similar events, the public safety officer is less likely to react to the current event in a biased manner (i.e., assume that this wellness check is the same as the many other similar alarm notifications they received from the same sensor and performed the wellness check in a non-urgent manner). Rather, the public safety officer may instead immediately perform the wellness check based on the emphasized significant difference. For example, the current wellness check event may have been reported by the neighbor because the individual actually fell and needs medical assistance as soon as possible.

Referring back to FIG. 4, the method 400 may include numerous optional steps (shown in dashed lines in FIG. 4). Any one or a combination of these optional steps may be present or absent in certain implementations. For example, at block 415, in response to determining that the first event is not similar to a plurality of previous events to which the first user has responded, the method 400 may proceed to block 435. At block 435, the second electronic processor 305 determines, based on the information regarding the first event, whether the first event is similar to a plurality of previous events to which one or more other user has responded, for example, by comparing each of the plurality of event parameters of the first event to a plurality of event parameters of the plurality of previous events to which the one or more other user has responded. In some instances, the second electronic processor 305 executes block 435 in a similar manner as described previously herein with respect to block 415 except that the previous events being compared to the first event were handled by other users besides the first user since there were no similarities between the first event and previous events that were handled by the first user.

In other words, the method 400 may be executed to first attempt to determine whether the first event is similar to a plurality of previous events to which the first user has responded (at block 415) because similar previous events handled by the user are most likely to cause potential bias that may exist in the first user's decision-making process with respect to the first event. However, in response to determining that the first event is not similar to a plurality of previous events to which the first user has responded, the method 400 may then proceed to attempt to determine whether the first event is similar to a plurality of previous events to which one or more other user has responded (at block 435). Even though such previous events were not handled by the first user, the first user may have been informed (e.g., by colleagues that handled the previous events) of previous similar events that are usually false alarms, for example, during a change in work shift or when covering someone else's work shift. Accordingly, execution of block 435 (and the succeeding steps described below) may nevertheless reduce or eliminate bias in the first user's decision-making in a similar manner as described previously herein with respect to blocks 415-425.

Alternatively, in some instances, at block 415, in response to determining that the first event is not similar to a plurality of previous events to which the first user has responded, the method 400 may terminate or proceed back to block 405 to repeat and evaluate additional received information. In such instances, the second electronic processor 305 may provide information about the first event to the communication device 105 of the first user without providing an indication of significant differences between the first event and previous similar events since the first event was not determined to be similar to a plurality of previous events to which the first user has responded. In some instances, the information provided to the communication device 105 indicates that the second electronic processor 305 determined that the first event is not similar to a plurality of previous events to which the first user has responded.

In response to determining that the first event is not similar to a plurality of previous events to which one or more other user has responded (at block 435), at block 440, the second electronic processor 305 provides, to a communication device associated with the first user, a notification regarding the first event and an indication that the first event is not similar to a plurality of any previous events handled by the first user or by other users. The method 400 may then proceed back to block 405 to repeat and evaluate additional received information.

On the other hand, in response to determining that the first event is similar to a plurality of previous events to which one or more other user has responded (at block 435), at block 445, the second electronic processor 305 determines whether there are any significant differences between the first event and the plurality of previous events to which the one or more other user has responded, for example, by comparing each of the plurality of event parameters of the first event to corresponding event parameters of the plurality of event parameters of the plurality of previous events to which the one or more other user has responded. In some instances, the second electronic processor 305 executes block 440 in a similar manner as described previously herein with respect to block 420.

In response to determining that there is a significant difference between the first event and the plurality of previous events to which the one or more other user has responded (at block 440), at block 425, the second electronic processor 305 provides, to a communication device 105 associated with the first user, a notification regarding the first event and an indication of the significant difference between the first event and the plurality of previous events to which the one or more other user has responded as described previously herein. On the other hand, in response to determining that there is not a significant difference between the first event and the plurality of previous events to which the one or more other user has responded (at block 440), at block 450, the second electronic processor 305 provides, to the communication device 105 associated with the first user, a notification regarding the first event and an indication that there are no significant differences compared to similar previous events to which one or more other user has responded.

Similarly, with reference back to block 420, in response to determining that there is not a significant difference between the first event and the plurality of previous events to which the first user has responded (at block 420), at block 430, the second electronic processor 305 provides, to the communication device associated with the first user, a notification regarding the first event and an indication that there are no significant differences compared to similar previous events to which the first user has responded.

In the above-noted situations in which no significant differences are identified, the second electronic processor 305 may nevertheless provide information about one or more previous similar events to allow the communication device 105 to display side-by-side information of each event for comparison by the first user. Such displaying of information may allow the first user to identify a significant difference that was not identified by the method 400. The communication device 105 may receive a user input regarding the significant difference identified by the first user and may provide information regarding the user input back to the second electronic processor 305 to modify and improve an algorithm and/or a machine learning model that is used to identify the significant difference(s) between events.

In the foregoing specification, specific embodiments have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment may be implemented as a computer-readable storage medium having computer readable code stored thereon for programming a computer (for example, comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. An electronic computing device comprising:
a network interface; and
an electronic processor coupled to the network interface, wherein the electronic processor is configured to
receive information regarding a first event, wherein the information regarding the first event includes a plurality of event parameters of the first event,
receive information regarding a first user selected to respond to the first event,
determine, based on the information regarding the first event and the information regarding the first user, whether the first event is similar to a plurality of previous events to which the first user has responded by comparing each of the plurality of event parameters of the first event to a plurality of event parameters of the plurality of previous events to which the first user has responded,
in response to determining that the first event is similar to the plurality of previous events to which the first user has responded, determine whether there are any significant differences between the first event and the plurality of previous events to which the first user has responded by comparing each of the plurality of event parameters of the first event to corresponding event parameters of the plurality of event parameters of the plurality of previous events to which the first user has responded, and
in response to determining that there is a significant difference between the first event and the plurality of previous events to which the first user has responded, provide, to a communication device associated with the first user, a notification regarding the first event and an indication of the significant difference.

2. The electronic computing device of claim 1, wherein the electronic processor is configured to determine whether the first event is similar to the plurality of previous events to which the first user has responded in response to determining that a predetermined amount of the plurality of event parameters of the first event include a first value that is the same as or within a predetermined range of a second value of a corresponding event parameter of the plurality of event parameters of the plurality of previous events to which the first user has responded.

3. The electronic computing device of claim 1, wherein the electronic processor is configured to determine whether the first event is similar to the plurality of previous events to which the first user has responded in response to:
determining that a triggering action that detected the first event is the same as a triggering action that detected the plurality of previous events to which the first user has responded; and
determining that a location of the first event is the same or within a predetermined proximity as a location of the plurality of previous events to which the first user has responded.

4. The electronic computing device of claim 1, wherein the electronic processor is configured to determine whether the first event is similar to the plurality of previous events to which the first user has responded by analyzing the plurality of event parameters of the first event using a machine learning model that was trained using (i) a plurality of event parameters of previous events and (ii) indications of whether the previous events were similar to each other.

5. The electronic computing device of claim 1, wherein the electronic processor is configured to determine whether there are any significant differences between the first event and the plurality of previous events to which the first user has responded by comparing each of the plurality of event parameters of the first event to corresponding event parameters of the plurality of event parameters of the plurality of previous events to which the first user has responded by determining whether an event parameter value of the first event is outside of a predetermined range, wherein the predetermined range is based on event parameter values of a corresponding event parameter of the plurality of previous events.

6. The electronic computing device of claim 1, wherein the electronic processor is configured to determine whether there are any significant differences between the first event and the plurality of previous events to which the first user has responded by comparing each of the plurality of event parameters of the first event to corresponding event parameters of the plurality of event parameters of the plurality of previous events to which the first user has responded using a machine learning model that was trained using (i) a plurality of event parameters of previous events and (ii) indications of whether each event parameter value of the plurality of event parameters of the previous events is significantly different than event parameter values of corresponding event parameters of other previous events.

7. The electronic computing device of claim 6, wherein the electronic processor is configured to:
receive, from the communication device, user feedback information that indicates which event parameters of the plurality of event parameters of the first event were useful to aid the first user in making a decision regarding how to handle the first event; and
update the machine learning model based on the user feedback information.

8. The electronic computing device of claim 1, wherein the indication of the significant difference is output via an output device of the communication device for consumption by the first user;
wherein the output device includes a display, a speaker, or both the display and the speaker; and
wherein the indication of the significant difference is output via the output device by at least one of a group consisting of (i) displaying information regarding the significant difference on the display as text in a manner that is distinguished from other displayed text, (ii) displaying, on the display, an image or video with an annotation or other distinguishing feature that emphasizes the significant difference, (iii) displaying a first selectable feature on the display that, in response to be selected by the first user, outputs audio regarding the significant difference via the speaker, (iv) displaying a second selectable feature on the display that, in response to be selected by the first user, emphasizes area in an image or video to highlight the significant difference or causes the display to display additional information about the significant difference, and (v) combinations thereof.

9. The electronic computing device of claim 8, wherein the indication of the significant difference includes simultaneously displaying, on the display of the communication device, a significantly different event parameter value of the first event and a corresponding event parameter value of one or more of the plurality of previous events.

10. The electronic computing device of claim 1, wherein the electronic processor is configured to receive a user input from the communication device, the user input indicating whether the electronic processor should take one or more security actions with respect to the first event, wherein the user input is received in response to a prompt regarding the first event that is displayed on the communication device along with the indication of the significant difference.

11. The electronic computing device of claim 1, the electronic processor is configured to:
in response to determining that the first event is not similar to the plurality of previous events to which the first user has responded, determine, based on the information regarding the first event, whether the first event is similar to a plurality of previous events to which one or more other user has responded by comparing each of the plurality of event parameters of the first event to a plurality of event parameters of the plurality of previous events to which the one or more other user has responded;
in response to determining that the first event is similar to the plurality of previous events to which the one or more other user has responded, determine whether there are any significant differences between the first event and the plurality of previous events to which the one or more other user has responded by comparing each of the plurality of event parameters of the first event to corresponding event parameters of the plurality of event parameters of the plurality of previous events to which the one or more other user has responded; and
in response to determining that there is a significant difference between the first event and the plurality of previous events to which the one or more other user has responded, providing, to a communication device associated with the first user, the notification regarding the first event and the indication of the significant difference between the first event and the plurality of previous events to which the one or more other user has responded.

12. A method of providing differentiating information included in similar events, the method comprising:
receiving, with an electronic processor of an electronic computing device, information regarding a first event, wherein the information regarding the first event includes a plurality of event parameters of the first event;
receiving, with the electronic processor, information regarding a first user selected to respond to the first event;
determining, with the electronic processor and based on the information regarding the first event and the information regarding the first user, whether the first event is similar to a plurality of previous events to which the first user has responded by comparing each of the plurality of event parameters of the first event to a plurality of event parameters of the plurality of previous events to which the first user has responded;
in response to determining that the first event is similar to the plurality of previous events to which the first user has responded, determining, with the electronic processor, whether there are any significant differences between the first event and the plurality of previous events to which the first user has responded by comparing each of the plurality of event parameters of the first event to corresponding event parameters of the plurality of event parameters of the plurality of previous events to which the first user has responded; and
in response to determining that there is a significant difference between the first event and the plurality of previous events to which the first user has responded, providing, with the electronic processor and to a communication device associated with the first user, a notification regarding the first event and an indication of the significant difference.

13. The method of claim 12, wherein determining whether the first event is similar to the plurality of previous events to which the first user has responded includes determining whether the first event is similar to the plurality of previous events to which the first user has responded in response to determining that a predetermined amount of the plurality of event parameters of the first event include a first value that is the same as or within a predetermined range of a second value of a corresponding event parameter of the plurality of event parameters of the plurality of previous events to which the first user has responded.

14. The method of claim 12, wherein determining whether the first event is similar to the plurality of previous events to which the first user has responded includes determining whether the first event is similar to the plurality of previous events to which the first user has responded in response to:
determining, with the electronic processor, that a triggering action that detected the first event is the same as a triggering action that detected the plurality of previous events to which the first user has responded; and
determining, with the electronic processor, that a location of the first event is the same or within a predetermined proximity as a location of the plurality of previous events to which the first user has responded.

15. The method of claim 12, wherein determining whether there are any significant differences between the first event and the plurality of previous events to which the first user has responded includes comparing, with the electronic processor, each of the plurality of event parameters of the first event to corresponding event parameters of the plurality of event parameters of the plurality of previous events to which the first user has responded by determining whether an event parameter value of the first event is outside of a predetermined range, wherein the predetermined range is based on event parameter values of a corresponding event parameter of the plurality of previous events.

16. The method of claim 12, wherein determining whether there are any significant differences between the first event and the plurality of previous events to which the first user has responded includes comparing, with the electronic processor, each of the plurality of event parameters of the first event to corresponding event parameters of the plurality of event parameters of the plurality of previous events to which the first user has responded using a machine learning model that was trained using (i) a plurality of event parameters of previous events and (ii) indications of whether each event parameter value of the plurality of event parameters of the previous events is significantly different than event parameter values of corresponding event parameters of other previous events.

17. The method of claim 16, further comprising:
receiving, with the electronic processor and from the communication device, user feedback information that indicates which event parameters of the plurality of event parameters of the first event were useful to aid the first user in making a decision regarding how to handle the first event; and
updating, with the electronic processor, the machine learning model based on the user feedback information.

18. The method of claim 12, further comprising outputting the indication of the significant difference via an output device of the communication device for consumption by the first user;
wherein the output device includes a display, a speaker, or both the display and the speaker; and
wherein outputting the indication of the significant difference includes at least one of a group consisting of (i) displaying information regarding the significant difference on the display as text in a manner that is distinguished from other displayed text, (ii) displaying, on the display, an image or video with an annotation or other distinguishing feature that emphasizes the significant difference, (iii) displaying a first selectable feature on the display that, in response to be selected by the first user, outputs audio regarding the significant difference via the speaker, (iv) displaying a second selectable feature on the display that, in response to be selected by the first user, emphasizes area in an image or video to highlight the significant difference or causes the display to display additional information about the significant difference, and (v) combinations thereof.

19. The method of claim 18, wherein outputting the indication of the significant difference includes simultaneously displaying, on the display of the communication device, a significantly different event parameter of the first event and a corresponding event parameter of one or more of the plurality of previous events.

20. The method of claim 12, further comprising:
in response to determining that the first event is not similar to the plurality of previous events to which the first user has responded, determining, with the electronic processor and based on the information regarding the first event, whether the first event is similar to a plurality of previous events to which one or more other user has responded by comparing each of the plurality of event parameters of the first event to a plurality of event parameters of the plurality of previous events to which the one or more other user has responded;
in response to determining that the first event is similar to the plurality of previous events to which the one or more other user has responded, determining, with the electronic processor, whether there are any significant differences between the first event and the plurality of previous events to which the one or more other user has responded by comparing each of the plurality of event parameters of the first event to corresponding event parameters of the plurality of event parameters of the plurality of previous events to which the one or more other user has responded; and
in response to determining that there is a significant difference between the first event and the plurality of previous events to which the one or more other user has responded, providing, with the electronic processor and to a communication device associated with the first user, the notification regarding the first event and the indication of the significant difference between the first event and the plurality of previous events to which the one or more other user has responded.
